(19) United States
(12) Patent Application Publication
(10) Pub. No.: US 2026/0057874 A1
(43) Pub. Date: Feb. 26, 2026

(54) AUDIO PROCESSING

(71) Applicant: Cirrus Logic International Semiconductor Ltd., Edinburgh (GB)

(72) Inventor: John P. LESSO, Edinburgh (GB)

(73) Assignee: Cirrus Logic International Semiconductor Ltd., Edinburgh (GB)

(21) Appl. No.: 19/226,575

(22) Filed: Jun. 3, 2025

Related U.S. Application Data
(60) Provisional application No. 63/685,762, filed on Aug. 22, 2024.
(60) Provisional application No. 63/691,068, filed on Sep. 5, 2024.

(51) Int. Cl. G10K 11/175; G10L 17/04; G10L 25/78; H04R 3/04; H04R 19/04

(52) U.S. Cl. CPC G10K 11/1754; G10L 17/04; G10L 25/78; H04R 3/04; H04R 19/04; H04R 2201/003

(57) ABSTRACT

1 A method of masking audible sound received at a device, the method comprising: outputting an ultrasonic signal to a transducer, the ultrasonic signal comprising ultrasonic content which, when received at a microphone of the device, is mixed into an audible band of an audio signal generated by the microphone in response to the audible sound and the ultrasonic signal; receiving the audio signal from the microphone; compensating the audio signal in dependence on the ultrasonic signal to obtain a compensated audio signal representing the audible sound.

### TECHNICAL FIELD

The present disclosure relates to methods of and apparatus for masking sound captured by microphones using ultrasound.

### BACKGROUND

Unauthorized audio recording, whether by malicious actors or unintended third-party devices, presents a significant privacy concern. Traditional methods of preventing eavesdropping often involve physical barriers or encryption techniques. However, these methods are not effective in scenarios where an individual attempts to record audio covertly using standard devices such as smartphones or voice recorders.

### SUMMARY

According to a first aspect of the disclosure, there is provided a method of masking audible sound received at a device, the method comprising: outputting an ultrasonic signal to a transducer, the ultrasonic signal comprising ultrasonic content which, when received at a microphone of the device, is mixed into an audible band of an audio signal generated by the microphone in response to the audible sound and the ultrasonic signal; receiving the audio signal from the microphone; compensating the audio signal in dependence on the ultrasonic signal to obtain a compensated audio signal representing the audible sound.

The compensating may comprise removing interference in the audio signal associated with the ultrasonic content mixed into the audible band.

A response of the microphone may be non-linear.

The microphone may comprise a micro-electromechanical system (MEMS) microphone or a condenser microphone.

The ultrasonic content may demodulate or mix into a baseband of the audio signal.

The ultrasonic content may be time-varying in amplitude and/or frequency. The ultrasonic content may comprise one or more chirps or swept content. The ultrasonic content may comprise one or more step changes in amplitude and/or frequency.

The ultrasonic content may be adapted in dependence on the sound represented in the audio signal.

The ultrasonic content may comprise detecting speech in the audio signal; and modulating the ultrasonic content based on a characteristic of the speech.

Adapting the ultrasonic content may comprise: detecting a fundamental frequency of the speech in the audio signal; and maintain the ultrasonic frequency within a threshold frequency range of the fundamental frequency.

Adapting the ultrasonic content may comprise modulating the ultrasonic content based on an envelope of the audio signal.

Adapting the ultrasonic content may comprise modulating the ultrasonic content based on an envelope of the articulation rate of the speech.

Adapting the ultrasonic content may comprise: enabling the ultrasonic content when speech is present in the audio signal; and disabling the ultrasonic content when speech is absent from the audio signal.

The method may comprise enabling the ultrasonic content when the device is an elevated security mode.

The ultrasonic content may be adapted based on a speech profile of a user. The speech profile may comprise one or more characteristics of speech of the user.

The speech profile may be generated based on a recording of speech of the user.

The one or more characteristics of the speech of the user may comprise one or more fundamental frequencies.

The method may further comprise recording the audio signal and/or the compensated audio signal The ultrasonic content is enabled during recording of the audio signal and/or the compensated audio signal.

The ultrasonic content may comprise signals having a frequency greater than 19 kHz and/or signals which are inaudible to a human ear.

The transducer may comprise an ultrasonic transducer or a transducer capable of outputting generating.

According to another aspect of the disclosure, there is provided circuitry for masking audible sound received at a device, the circuitry configured to: output an ultrasonic signal to a transducer, the ultrasonic signal comprising ultrasonic content which, when received at a microphone of the device, is mixed into an audible band of an audio signal generated by the microphone in response to the audible sound and the ultrasonic signal; receive an audio signal from a microphone; and compensate the audio signal in dependence on the ultrasonic signal to obtain a compensated audio signal representing the audible sound.

According to another aspect of the disclosure, there is provided a method of masking audible sound received at a device, the method comprising: outputting an ultrasonic signal to a transducer, the ultrasonic signal comprising ultrasonic content which, when received at a microphone of the device, is mixed into an audible band of an audio signal generated by the microphone in response to the audible sound and the ultrasonic signal; receiving the audio signal from the microphone; adapting the ultrasonic content of the ultrasonic signal in dependence on a characteristic of the audio signal.

Adapting the ultrasonic content may comprise: adapting a frequency of the ultrasonic content in dependence on a fundamental frequency of speech in the audio signal.

According to another aspect of the disclosure, there is provided circuitry for masking audible sound received at a device, the circuitry configured to: output an ultrasonic signal to a transducer, the ultrasonic signal comprising ultrasonic content which, when received at a microphone of the device, is mixed into an audible band of an audio signal generated by the microphone in response to the audible sound and the ultrasonic signal; receive an audio signal from the microphone; and adapt the ultrasonic content of the ultrasonic signal in dependence on a characteristic of the audio signal.

According to another aspect of the disclosure, there is provided a method of speech or speaker detection in a device, comprising: receiving a speech signal; generating an ultrasound signal; detecting a reflection of the generated ultrasound signal; detecting Doppler shifts in the reflection of the generated ultrasound signal; identifying whether the received speech signal is likely to be spoken by a user proximate the device based on the detected Doppler shifts; and if the likelihood of the user being proximate the device exceeds a threshold, performing speech or speaker detection.

The step of performing speech or speaker detection may comprise one of: determining the presence of speech in the speech signal; determining a change in speech between the user and another user; determining the identity of the speaker; determining the content of the speech; and enrolling the user as an enrolled user of the device.

Performing speech of speaker detection may comprise: identifying the user as an enrolled user; and enriching a model or a profile of the enrolled user based on the speech signal.

According to another aspect of the disclosure, there is provided circuitry for speech or speaker detection in a device, the circuitry configured to: receive a speech signal; generate an ultrasound signal; detect a reflection of the generated ultrasound signal; detect Doppler shifts in the reflection of the generated ultrasound signal; identifying whether the received speech signal is likely to be spoken by a user proximate the device based on the detected Doppler shifts; and if the likelihood of the user being proximate the device exceeds a threshold, performing speech or speaker detection.

According to another aspect of the disclosure, there is provided an integrated circuit (IC) comprising the circuitry described above.

According to another aspect of the disclosure, there is provided a system comprising: the circuitry described above; the transducer; and the microphone.

According to another aspect of the disclosure, there is provided an electronic device comprising the apparatus, integrated circuit, or system described above.

The electronic device may comprise one of a smartphone, a personal computer, a personal audio device, a games console, a home control system, a home entertainment system, and an in-vehicle entertainment system.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the present disclosure will now be described by way of non-limiting examples with reference to the drawings, in which:

FIG. 1 illustrates a device;

FIG. 2 is a schematic diagram of the device of FIG. 1;

FIG. 3 graphically illustrate mixing of ultrasonic content into audio signals due to device non-linearities;

FIG. 4 is a schematic diagram of an example processing system which may be implemented by the device of FIG. 1; and

FIG. 5 is a schematic diagram of an example implementation of the comparison circuitry of FIG. 4.

### DESCRIPTION OF EMBODIMENTS

The description below sets forth example embodiments according to this disclosure. Further example embodiments and implementations will be apparent to those having ordinary skill in the art. Further, those having ordinary skill in the art will recognize that various equivalent techniques may be applied in lieu of, or in conjunction with, the embodiments discussed below, and all such equivalents should be deemed as being encompassed by the present disclosure.

The methods described herein can be implemented in a wide range of devices and systems, for example a mobile telephone, an audio player, a video player, a mobile computing platform, a games device, a remote controller device, a toy, a machine, or a home automation controller or a domestic appliance. However, for ease of explanation of one embodiment, an illustrative example will be described, in which the implementation occurs in a personal computer (e.g. a laptop).

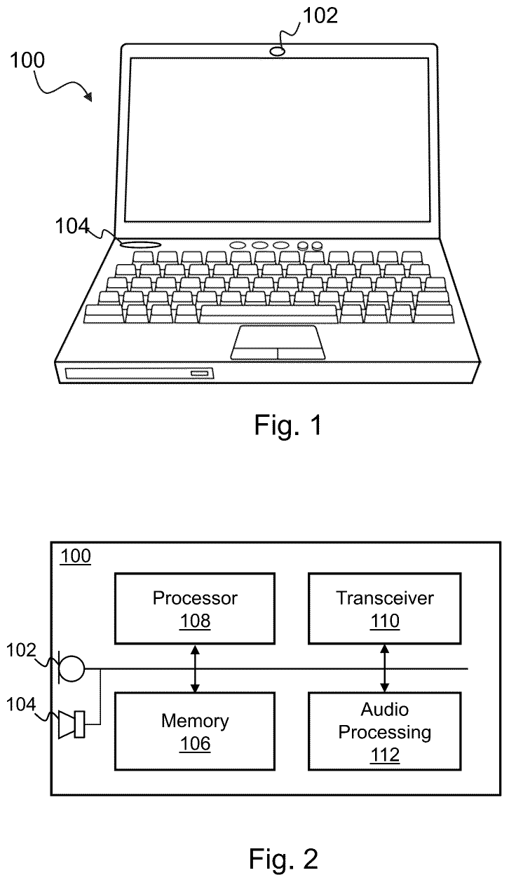

FIG. 1 illustrates an audio device 100, such as a personal computer, having a microphone 102 for detecting ambient sounds and an output transducer 104, such as a loudspeaker for outputting audio. In normal use, the microphone 102 may be used for capturing speech of a user of the device 100 and the output transducer 104 may be used for playback of audio, such as media, speech, and the like. The output transducer 104 may be capable of outputting ultrasound. The output transducer 104 may, for example, be a dedicated ultrasonic transducer. Where the output transducer 104 is a dedicated ultrasonic transducer, the audio device 100 may comprise an additional output transducer (not shown) for outputting audible sound, such as for the playback of media, speech etc. Using the microphone 102 and the output transducer 104, the audio device 100 may be used for voice over internet protocol (VOIP) calls. In this example, a microphone 102 and output transducer 104 are integrated into the audio device 100. In other examples, the microphone 102 and output transducer 104 may be peripheral devices. Additionally, or alternatively, one or more peripheral microphones and/or output transducers may be provided. For example, the audio device 100 may be used with a headset or earphones which may comprise the microphone 102 and/or the output transducer 104.

FIG. 2 is a schematic diagram illustrating the form of the device 100. Specifically, FIG. 2 shows various interconnected components of the device 100. It will be appreciated that the device 100 will in practice contain many other components, but the following description is sufficient for an understanding of the present disclosure.

Thus, FIG. 2 shows the microphone 102 and an output transducer 104, as mentioned above.

The device 100 also comprise a memory 106, which may in practice be provided as a single component or as multiple components. The memory 106 is provided for storing data and program instructions.

The device 100 also comprises a processor 108, which again may in practice be provided as a single component or as multiple components. For example, one component of the processor 108 may be an applications processor of the device 100.

The device 100 also comprises a transceiver 110, which is provided for allowing the device 100 to communicate with external networks. For example, the transceiver 110 may include circuitry for establishing an internet connection either over a Wi-Fi local area network or over a cellular network.

Th device 100 also comprises audio processing circuitry 112, for performing operations on audio signals captured by the microphone 102 or to be output to the output transducer 104, as required. For example, the audio processing circuitry 112 may filter and/or amplify the audio signals or perform other signal processing operations. The audio processing circuitry 112 may comprise one or more digital to analog converters (DACs). The audio processing circuitry 112 may comprise one or more analog to digital converters (ADCs). The audio processing circuitry 112 may comprise one or more audio codecs. The audio processing circuitry 112 may comprise one or more digital signal processors (DSPs).

The output transducer 104 may be configured to output audio content at frequencies audible to a human ear, for example 20 Hz to 20 kHz. In addition, the output transducer 104 may be configured to output audio content at ultrasonic frequencies, for example above frequencies audible to a human ear or above of 20 KHz.

The device 100 may be provided with voice biometric functionality, and with control functionality. For example, the device 100 may be able to perform various functions in response to spoken commands from an enrolled user. The biometric functionality is able to distinguish between spoken commands from the enrolled user, and the same commands when spoken by a different person. Thus, certain embodiments of the invention relate to operation of a smartphone or another portable electronic device with some sort of voice operability, for example a tablet or laptop computer, a games console, a home control system, a home entertainment system, an in-vehicle entertainment system, a domestic appliance, or the like, in which the voice biometric functionality is performed in the device that is intended to carry out the spoken command. Certain other embodiments relate to systems in which the voice biometric functionality is performed on a smartphone or other device, which then transmits the commands to a separate device if the voice biometric functionality is able to confirm that the speaker was the enrolled user.

In some embodiments, while voice biometric functionality is performed on the device 100 or other device that is located close to the user, the spoken commands are transmitted using the transceiver 110 to a remote speech recognition system (not shown), which determines the meaning of the spoken commands. For example, the speech recognition system may be located on one or more remote server in a cloud computing environment. Signals based on the meaning of the spoken commands are then returned to the device 100 or another local device. In other embodiments, the speech recognition system is also located on the device 100.

There may be inherent non-linearity in various audio components of the device 100 shown in FIG. 2. For example, non-linearity may be in the microphone 102. For example, non-linearity may be in the audio processing circuitry 112 (for example, in an ADC, DAC, DSP or amplifier of the audio processing circuitry 112).

The effect of this is non-linearity in the circuitry is that ultrasonic tones incident the microphone 102 may demodulate or mix down into an audio band, such as the baseband. This effect is inherent to both condenser microphones and MEMS microphones.

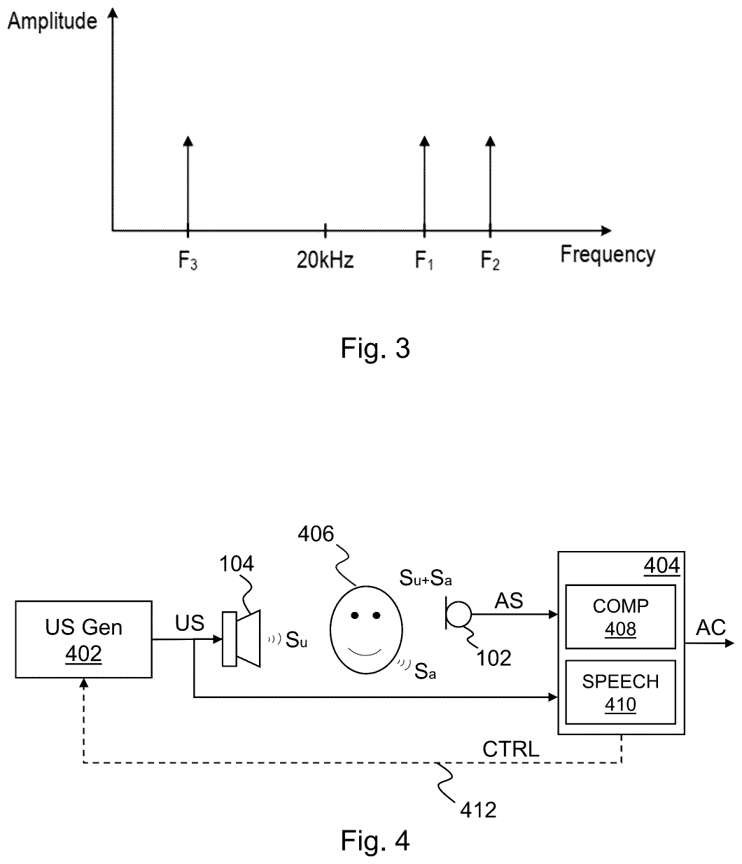

FIG. 3 illustrates this schematically. Specifically, FIG. 3 shows a situation in which ultrasound (i.e. at frequencies >20 kHz) is incident the microphone 102 at two frequencies, F1 and F2. Due to circuit non-linearity, these components of ultrasound mix down to form a signal at a frequency F3 in the audio frequency range (i.e. at frequencies between about 20 Hz and 20 kHz).

Embodiments of the present disclosure aim to utilise this demodulating effect of non-linear circuit elements to provide inaudible audio masking of sound received at the microphone 102. In doing so, unauthorised recording of audio signals captured by a microphone can be prevented, without the need for physical barriers or encryption techniques. Such solutions are effective in scenarios where an individual attempts to record audio covertly using standard devices such as smartphones or voice recorders.

To counteract such eavesdropping techniques, embodiments of the present disclosure provide methods and circuitry for generating and outputting ultrasonic content from the output transducer 104 engineered to demodulate, mix or fold down into the audio frequency range of (electrical) audio signals generated by the microphone 102. Audible sound content captured by a microphone of a malicious actor's device, or by the microphone 102 of the device 100, may be indecipherable due to the presence of interference or distortion, rendering the audio signal useless to a malicious actor. However, with knowledge of the injected ultrasonic content, compensation can be applied to the captured audio to remove the ultrasonic content, resulting in an audio signal at the device 100 comprising only audible sound, such as the speech of a user of the device 100.

Thus, in embodiments of the present disclosure, ultrasonic tones or content can be output from the output transducer 104 while audio captured by the microphone 102 is being recorded. Compensation can be applied to the recorded audio signal to produce a clean recording while inhibiting the quality of any unauthorised recordings.

The generated ultrasonic content or tones may be time-varying in amplitude and/or frequency, and may include chirps, swept tones, or discontinuous signals to prevent third parties from adapting to the presence of such content. Furthermore, the tones can be adapted based on characteristics of the recorded audio, such as the fundamental frequency (F0) of a speaker's voice, or a user-specific voice profile stored on the device, as will be described in more detail below.

It will be appreciated that ultrasonic content may be generated by the output transducer 104 whether or not recording of audio proximate the device 100 is being undertaken.

Circuitry described herein may be integrated into an integrated circuit (IC), such as an audio codec, and can be incorporated into various electronic devices, including but not limited to personal computers such as laptops, smartphones, and tablets.

FIG. 4 is an example audio system 400 which may be implemented by the audio processing circuitry 112 of the device 100. The system 400 comprises an ultrasound (US) generator 402 and processing circuitry 404. Each of the US generator 402 and processing circuitry 404 may be implemented by the audio processing circuitry 112, the processor 108 or a combination thereof.

The US generator 402 is configured to generate an ultrasonic signal US containing ultrasonic content or tones. The US generator 402 is further configured to output the ultrasonic signal US to the output transducer 104, which may convert the (electrical) ultrasonic signal US to ultrasound Su. The US generator 402 may be configured to generate the ultrasonic signal US in various forms. For example, the ultrasonic signal US may comprise tones in a frequency range outside of the frequency range of the human ear, such as frequencies above 20 kHz. Additionally, the ultrasonic signal US may comprise tones in excess of the frequency range of some human ears or at the top end of the frequency range of the human ear, such as frequencies above 19 kHz or above 18 kHz. The ultrasonic signal US may be generated in such a way that ultrasonic tones contained therein are folded into the audible range, thereby masking or distorting audible sound Sa picked up by microphones, such as the microphone 102 and microphones of listening or recording devices proximate the transducer 104.

Audible sound SA may be generated by various sound sources in the vicinity of the microphone 102 and the output transducer 104. In the example shown in FIG. 4, a user 406 of the device 100 generates the audible sound SA in the form of speech.

Thus, ultrasound Su and audible sound Sa incident the microphone 102 are converted to an audio signal AS by the microphone 102. As noted above with reference to FIG. 3, this audio signal AS contains a representation of the audible sound Sa (e.g. generated by the user) in addition to interfering audio content (e.g. distortion) present due to demodulation of the ultrasound Su by the microphone 102. The audio signal AS is provided to the processing circuitry 404.

The processing circuitry 404 comprises compensation circuitry 408. Optionally, the processing circuitry 404 also comprises speech processing circuitry 410.

The compensation circuitry 408 is configured to receive the audio signal AS from the microphone 102 and remove the interfering audio content from the audio signal AS and output a compensated audio signal AC representing the audible sound Su incident the microphone 102.

The ultrasonic signal US may comprise one or more tones which are modulated around an ultrasonic band. For example, the ultrasonic signal US may comprise a tone at, say 500 Hz, which has been modulated up to 24 kHz. The non-linear nature of the microphone 102 is such that when the ultrasonic signal US is output from the output transducer 104 and the ultrasound Su reaches the microphone 102, that signal is demodulated back into the baseband such that the audio signal SA comprises an interfering tone at 500 Hz, substantially distorting or masking the audible sound Sa which was also present in the audio signal AS. In the extreme, such distortion will lead to the audible sound Sa being incomprehensible in the audio signal AS. For example, a broadband ultrasonic signal US may lead to total obscurity of the audible sound Sa. Notwithstanding, even slight mixing or demodulation will lead to speech of the user 406 comprised in the audio signal AS being unrecognisable as that of the user 406. Thus, such techniques can be used not only to maintain privacy of certain conversations or recordings of the user 406 but also mitigate against voice cloning.

To increase the robustness of voice capture mitigation, the frequency and/or amplitude of baseband tone(s) comprised in the ultrasonic signal US may be time-varying. For example, the ultrasonic signal US may comprise one or more chirps or swept tones, such that the resultant mixing results in sweeping of a tone over the audible frequency bands in the audio signal output from the microphone 102. In another example, the baseband tones may be discontinuous. For example, the ultrasonic signal US may jump in amplitude and/or frequency. Such a signal structure may mitigate against third party devices adapting to the presence of ultrasonic tones proximate that device 100.

To compensate for the presence of demodulated audio in the audio signal AS, the compensation circuitry 408 may have knowledge of one or more characteristics of the ultrasonic signal US injected into the output transducer 104. For example, the compensation circuitry 408 may be aware of the specific ultrasonic tones comprised in the ultrasonic signal US. Optionally, the compensation circuitry 408 may communicate with the US generator 402 (denoted by the dashed line 412 in FIG. 4). For example, the compensation circuitry 408 may control the US generator 402 to include specific tones in the ultrasonic signal US. Additionally, or alternatively, the US generator 402 may share the ultrasound signal US, a representation thereof, or one or more characteristics of the ultrasound signal US with the compensation circuitry 408. Additionally, or alternatively, a separate controller (not shown) may be provided which may controls one or both of the US generator 402 and/or provide information associated with the ultrasound signal US to the compensation circuitry 408. Such a controller may be provided as part of the processing circuitry 404 or may be provided separate from the processing circuitry 404.

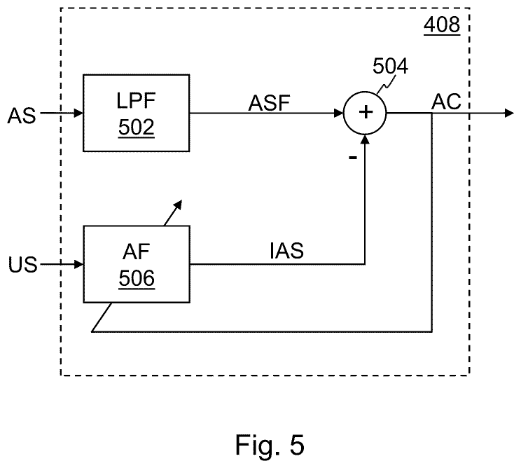

FIG. 5 is a schematic diagram of an example implementation of the compensation circuitry 408. In this example, the compensation circuitry 408 comprises a low pass filter 502, a subtractor 504 and an adaptive filter 506.

The audio signal AS is provided to the low pass filter 502 to remove any high frequency components of the audio signal AS generated by the microphone 102. The filtered audio signal ASF is provided to the subtractor 504.

The ultrasonic signal US which is also output to the output transducer 104 is provided to an input of the adaptive filter 506. The adaptive filter 506 is configured to generate an interfering audio signal IAS representing the downmixed interfering audio present in the audio signal AS. The interfering audio signal IAS is provided to the subtractor 504 where is it subtracted from the filtered audio signal ASF to generate the compensated audio signal AC. The compensated audio signal AC is provided as an input to the adaptive filter 506. The adaptive filter may implement one or more machine learning algorithms to arrive at the interfering audio signal IAS in dependence on the ultrasound signal US and the compensated audio signal AC.

Referring again to FIG. 4, optional speech processing circuitry 410 may be provided as part of the processing circuitry 404. The speech processing circuitry 410 may comprise a voice activity detector (VAD) configured to detect whether speech is present in the audio signal AS. The output of such voice activity detection may be used by the compensation circuitry 408 and/or the US generator 402 to trigger compensation and/or generation of the ultrasound signal US. For example, upon detection of speech in the audio signal by the speech processing circuitry, the US generator 402 may be configured to enable the ultrasound signal US. Conversely, when it is determined that speech is not present in the audio signal, the US generator may be configured to disable the ultrasound signal US.

The speech processing circuitry 410 may be configured to determine one or more characteristics of speech present in the audio signal AS. Such characteristics may include a fundamental frequency F0 of speech in the audio signal AS. Such characteristics may be provided to the US generator 402, which may generate tones of the ultrasound signal US based on the one or more characteristics. For example, the frequency of tones or content of the ultrasound signal US may be determined based on the fundamental frequency F0 of the speech in the audio signal AS. For example, tones of the ultrasound signal US may be modulated around the fundamental frequency F0 of the speech in the audio signal.

In addition, or an alternative, to the speech processing circuitry 410 determining characteristics of speech present in the audio signal AS, it may be possible to allow users of the device 100 to create a voice profile which may be stored in the memory 106. A voice profile may be created and stored during an enrolment process in which the speech processing circuitry 410 is configured to determine one or more characteristics of the user's voice (e.g. through the user speaking proximate the microphone 102). Such characteristics may include a fundamental frequency FO of the user's voice. Thus, a voice profile may be used instead of or in addition to the one or more characteristics obtained during live processing of the audio signal AS by the speech processing circuitry 410 to adapt or control the ultrasound signal US. In doing so, the masking effect of the ultrasound signal US may be enhanced for that particular user.

In some embodiments, the speech processing circuitry 410 may implement speaker recognition to identify the user 406 as an enrolled user. Speaker recognition (also referred to as voice biometrics) is known in the art and so will not be described in detail here. In response to a determination that speech or voice in the audio signal is that of an enrolled user, a voice profile associated with that enrolled user may be used to set one or more parameters of the ultrasound signal US. Again, in doing so, the masking effect of the ultrasound signal US may be enhanced for that particular user.

The processing circuitry 404 may be additionally configured to record or store the audio signal AS in memory, such as the memory 106. Such recording may be for any conceivable use, non-limiting examples including voice biometrics, secure transactions, VOIP calls, and the like. The injection of ultrasound signal US by the US generator may be gated based on whether recording is taking place and/or on whether a particular conversation requires additional security. For example, if a recording is taking place, the US generator 402 may generate the ultrasound signal US. If a recording is not taking place, the US generator 402 may not generate the ultrasound signal US. In another example, the ultrasonic signal US may be injected during periods in which speech of the user 406 is likely to contain sensitive information, such as during a phone call, a secure transaction, or an interaction with one or more applications running on the device 100.

Thus, the present disclosure provides systems and methods of mitigating against unauthorized audio listening and/recording by generating ultrasonic tones that are mixed into the audible range when converted into electrical signals by a microphone such as the microphone 102. Such mixing down or demodulation leads to distortion or masking of audible content (such as speech) of the resultant audio signal. Interfering audio content in the resultant audio signal can be removed by the described methods, enabling the device 100 itself to produce a clean audio signal representing audible sound (e.g. speech) while inhibiting unauthorized listening or recordings by third party devices. The present disclosure is applicable in various electronic devices, including personal computers (e.g. laptops), smartphones, and tablets, and can be implemented in an integrated circuit (IC), such as a codec IC.

Embodiments of the present disclosure also relates to methods and system for determining a likelihood that a user of the device 100 is speaking based on a comparison of the ultrasonic signal US and ultrasonic content in the audio signal AS generated by the microphone 102. Such a comparison may be based on determining Doppler shifts between the ultrasonic signal US and ultrasonic content of the audio signal AS. Such techniques are described in U.S. Pat. Nos. 11,705,135 and 11,017,252, the contents of which are hereby incorporated by reference in their entirety. Such processes are known from these documents and so will not be described in more detail here.

The determination of likelihood that the user 406 of the device 100 is speaking may be used as an input to one or more speaker detection techniques which may be implemented by the processing circuitry 404. Non-limiting examples of such speaker detection techniques will now be described.

In an example, a determination of a likelihood of the user speaking may be used in voice activity detection.

In another example, the likelihood determination may be used for antispoofing or liveness detection. For example, the likelihood determination may be used to determine whether the audio signal AS comprises speech which was captured from a live person, i.e. from the user 406, or from a replay of the user's speech (or someone else's speech) via a loudspeaker playing back the user's 406 (or someone else's) speech.

In another example, the likelihood determination may be used in a speaker-change detection method to determine a change of speaker, for example, between the user 406 and another user.

In another example, the likelihood determination may be used for enrolment of a user in a speaker or speech recognition system. Such enrolment may be passive, such that the user 406 may not be aware that enrolment is taking place. Such enrolment may comprise enrichment of a model or profile associated with the user 406. For example, on determination that it is likely that the speech is that of someone proximate the device 100, such as the user 406, speech obtained from the microphone 102 may be used to enrich a model associated with that user 406.

As is conventional, the signal may be divided into frames, for example of 10-100 ms duration. The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus, the code may comprise conventional program code or microcode or, for example code for setting up or controlling an ASIC or FPGA. The code may also comprise code for dynamically configuring re-configurable apparatus such as re-programmable logic gate arrays. Similarly, the code may comprise code for a hardware description language such as Verilog™ or VHDL (Very high-speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general-purpose processor or the like. A module may itself comprise other modules or functional units. A module may be provided by multiple components or sub-modules which need not be co-located and could be provided on different integrated circuits and/or running on different processors.

Embodiments may be implemented in a host device, especially a portable and/or battery powered host device such as a mobile computing device for example a laptop or tablet computer, a games console, a remote-control device, a home automation controller, or a domestic appliance including a domestic temperature or lighting control system, a toy, a machine such as a robot, an audio player, a video player, or a mobile telephone for example a smartphone.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A method of masking audible sound received at a device, the method comprising:
outputting an ultrasonic signal to a transducer, the ultrasonic signal comprising ultrasonic content which, when received at a microphone of the device, is mixed into an audible band of an audio signal generated by the microphone in response to the audible sound and the ultrasonic signal;
receiving the audio signal from the microphone;
compensating the audio signal in dependence on the ultrasonic signal to obtain a compensated audio signal representing the audible sound.

2. The method of claim 1, wherein the compensating comprises removing interference in the audio signal associated with the ultrasonic content mixed into the audible band.

3. The method of claim 1, wherein a response of the microphone is non-linear.

4. The method of claim 1, wherein the microphone comprises a micro-electromechanical system (MEMS) microphone.

5. The method of claim 1, wherein the ultrasonic content mix into a baseband of the audio signal.

6. The method of claim 1, wherein the ultrasonic content is time-varying in amplitude and/or frequency.

7. The method of claim 1, wherein the ultrasonic content comprises one or more chirps or swept content.

8. The method of claim 1, wherein the ultrasonic content comprises one or more step changes in amplitude and/or frequency.

9. The method of claim 1, wherein the ultrasonic content is adapted in dependence on the sound represented in the audio signal.

10. The method of claim 9, wherein adapting the ultrasonic content comprises:
detecting speech in the audio signal; and
modulating the ultrasonic content based on a characteristic of the speech.

11. The method of claim 10, wherein adapting the ultrasonic content comprises:
detecting a fundamental frequency of the speech in the audio signal; and
maintain the ultrasonic frequency within a threshold frequency range of the fundamental frequency.

12. The method of claim 10, wherein adapting the ultrasonic content comprises:
modulating the ultrasonic content based on an envelope of the audio signal.

13. The method of claim 10, wherein adapting the ultrasonic content comprises:
modulating the ultrasonic content based on an envelope of the articulation rate of the speech.

14. The method of claim 9, wherein adapting the ultrasonic content comprises:
enabling the ultrasonic content when speech is present in the audio signal; and
disabling the ultrasonic content when speech is absent from the audio signal.

15. The method of claim 1, comprising enabling the ultrasonic content when the device is an elevated security mode.

16. The method of claim 1, wherein the ultrasonic content is adapted based on a speech profile of a user, the speech profile comprising one or more characteristics of speech of the user.

17. The method of claim 16, wherein the speech profile is generated based on a recording of speech of the user.

18. The method of claim 16, wherein the one or more characteristics of the speech of the user comprises one or more fundamental frequencies.

19. The method of claim 1, further comprising recording the audio signal and/or the compensated audio signal

20. The method of claim 19, wherein the ultrasonic content is enabled during recording of the audio signal and/or the compensated audio signal.

21. The method of claim 1, wherein the ultrasonic content comprises signals having a frequency greater than 19 kHz or signals which are inaudible to a human ear.

22. The method of claim 1, wherein the transducer comprises an ultrasonic transducer.

23. Circuitry for masking audible sound received at a device, the circuitry configured to:
output an ultrasonic signal to a transducer, the ultrasonic signal comprising ultrasonic content which, when received at a microphone of the device, is mixed into an audible band of an audio signal generated by the microphone in response to the audible sound and the ultrasonic signal;
receive an audio signal from a microphone; and
compensate the audio signal in dependence on the ultrasonic signal to obtain a compensated audio signal representing the audible sound.

24. A method of masking audible sound received at a device, the method comprising:
outputting an ultrasonic signal to a transducer, the ultrasonic signal comprising ultrasonic content which, when received at a microphone of the device, is mixed into an audible band of an audio signal generated by the microphone in response to the audible sound and the ultrasonic signal;
receiving the audio signal from the microphone;
adapting the ultrasonic content of the ultrasonic signal in dependence on a characteristic of the audio signal.

25. The method of claim 24, wherein adapting the ultrasonic content comprises:
adapting a frequency of the ultrasonic content in dependence on a fundamental frequency of speech in the audio signal.

26. Circuitry for masking audible sound received at a device, the circuitry configured to:
output an ultrasonic signal to a transducer, the ultrasonic signal comprising ultrasonic content which, when received at a microphone of the device, is mixed into an audible band of an audio signal generated by the microphone in response to the audible sound and the ultrasonic signal;
receive an audio signal from the microphone; and
adapt the ultrasonic content of the ultrasonic signal in dependence on a characteristic of the audio signal.

27. A method of speech or speaker detection in a device, comprising:
receiving a speech signal;
generating an ultrasound signal;
detecting a reflection of the generated ultrasound signal;
detecting Doppler shifts in the reflection of the generated ultrasound signal;
identifying whether the received speech signal is likely to be spoken by a user proximate the device based on the detected Doppler shifts; and
if the likelihood of the user being proximate the device exceeds a threshold, performing speech or speaker detection.

28. The method of claim 27, wherein the step of performing speech or speaker detection comprises one of:
determining the presence of speech in the speech signal;
determining a change in speech between the user and another user;
determining the identity of the speaker;
determining the content of the speech;
enrolling the user as an enrolled user of the device.

29. The method of claim 28, wherein performing speech of speaker detection comprises:
identifying the user as an enrolled user; and
enriching a model or a profile of the enrolled user based on the speech signal.

30. Circuitry for speech or speaker detection in a device, the circuitry configured to:
receive a speech signal;
generate an ultrasound signal;
detect a reflection of the generated ultrasound signal;
detect Doppler shifts in the reflection of the generated ultrasound signal;
identifying whether the received speech signal is likely to be spoken by a user proximate the device based on the detected Doppler shifts; and
if the likelihood of the user being proximate the device exceeds a threshold, performing speech or speaker detection.

31. An integrated circuit (IC) comprising the circuitry of claim 23.

32. A system comprising:
the circuitry of claim 23;
the transducer; and
the microphone.

33. An electronic device comprising the of claim 23, wherein the electronic device comprises one of a smartphone, a personal computer, a personal audio device, a games console, a home control system, a home entertainment system, and an in-vehicle entertainment system.

34. (canceled)
